(19) United States
(12) Patent Application Publication
(10) Pub. No.: US 2024/0046222 A1
(43) Pub. Date: Feb. 8, 2024

(54) ARTIFICIAL INTELLIGENCE MODELS FOR DYNAMIC SCHEDULING

(71) Applicant: Sport Clips, Inc., Georgetown, TX (US)

(72) Inventors: Trey Roeder, Georgetown, TX (US); Edward Logan, Georgetown, TX (US)

(21) Appl. No.: 18/364,347

(22) Filed: Aug. 2, 2023

Related U.S. Application Data
(60) Provisional application No. 63/370,204, filed on Aug. 2, 2022.
(60) Provisional application No. 63/370,210, filed on Aug. 2, 2022.
(60) Provisional application No. 63/403,922, filed on Sep. 6, 2022.

(51) Int. Cl. G06Q 10/1093; G06Q 10/04

(52) U.S. Cl. CPC G06Q 10/1095; G06Q 10/04

(57) ABSTRACT

Systems and methods of providing artificial intelligence models for dynamic scheduling are provided. The models may be used by AI-based systems to calculate estimated wait times for clients associated with different services. Multiple data inputs may include a number of clients currently in queue, number of stylists available, distance of client to salon, or other data points. Custom user interfaces may be generated and displayed at different user devices. Such custom interfaces may include estimated wait time and digital options selectable to enter a queue. Additional options may include an option to select a preferred stylist or other service provider even if that would lead to greater wait times. Clients may also choose to be assigned to a stylist that would finish the service quicker, even with a later start time.

### CROSS-REFERENCE TO RELATED APPLICATIONS

The present patent application claims the priority benefit of U.S. provisional patent application 63/370,204 filed Aug. 2, 2022, U.S. provisional patent application 63/370,210 filed Aug. 2, 2022, and U.S. provisional patent application 63/403,922 filed Sep. 6, 2022, the disclosures of which are incorporated by reference herein.

### BACKGROUND OF THE CLAIMED INVENTION

### 1. Field of the Disclosure

The present disclosure is generally related to service provider systems. More specifically, the present disclosure is related to providing artificial intelligence models for dynamic scheduling.

### 2. Description of the Related Art

Presently available service providers rely on manual or static scheduling systems that are inflexible, difficult to change, or result in extended delays. For example, salon clients typically have two options when setting a time to get their haircut. They can either make an appointment or “walk-in”. Both of these options have downsides for the client. Appointments require booking days or even weeks in advance, while walking in may require the client to wait for an extended period of time for a stylist to become available. Integrating these two systems can present problems. A stylist may want to see a walk-in client but may have an appointment soon. The stylist may have to risk upsetting the client with an appointment in order to see the client who is present.

Methods of estimating how long a haircut or other service will take are very basic and do not account for variables such as time of day, day of week, weather patterns, or the rapport between a specific stylist and client. Further, current methods do not optimize the assignment of client to stylist to minimize overall service time and/or idle time.

There is therefore a need in the art for improved systems and methods of providing artificial intelligence models for dynamic scheduling.

### SUMMARY OF THE CLAIMED INVENTION

Embodiments of the present invention may include systems and methods of constructing artificial intelligence models for dynamic scheduling systems are provided. The models may be used by AI-based systems to calculate estimated wait times for clients associated with different services. Multiple data inputs may include a number of clients currently in queue, number of stylists available, distance of client to salon, or other data points. Custom user interfaces may be generated and displayed at different user devices. Such custom interfaces may include estimated wait time and digital options selectable to enter a queue. Additional options may include an option to select a preferred stylist or other service provider even if that would lead to greater wait times. Clients may also choose to be assigned to a stylist that would finish the service quicker, even with a later start time.

### BRIEF DESCRIPTION OF THE DRAWINGS

FIG. 1 illustrates an exemplary network environment in which a system of constructing artificial intelligence models for dynamic scheduling may be implemented

FIG. 2A illustrates an exemplary schedule database that may be used in methods of constructing artificial intelligence models for dynamic scheduling.

FIG. 2B illustrates an exemplary waitlist database that may be used in methods of constructing artificial intelligence models for dynamic scheduling.

FIG. 2C illustrates an exemplary client database that may be used in methods of constructing artificial intelligence models for dynamic scheduling.

FIG. 3 is a flowchart illustrating an exemplary method of dynamic scheduling based on artificial intelligence models.

FIG. 4 is a flowchart illustrating an exemplary method of constructing and training artificial intelligence models for dynamic scheduling.

FIG. 5 is a flowchart illustrating an exemplary method of dynamically modifying schedules based on artificial intelligence models.

FIG. 6 is a block diagram of an exemplary computing device that may be used to implement an embodiment of the present invention.

### DETAILED DESCRIPTION

Embodiments of the present invention may include systems and methods of constructing artificial intelligence models for dynamic scheduling systems are provided. The models may be used by AI-based systems to calculate estimated wait times for clients associated with different services. Multiple data inputs may include a number of clients currently in queue, number of stylists available, distance of client to salon, or other data points. Custom user interfaces may be generated and displayed at different user devices. Such custom interfaces may include estimated wait time and digital options selectable to enter a queue. Additional options may include an option to select a preferred stylist or other service provider even if that would lead to greater wait times. Clients may also choose to be assigned to a stylist that would finish the service quicker, even with a later start time.

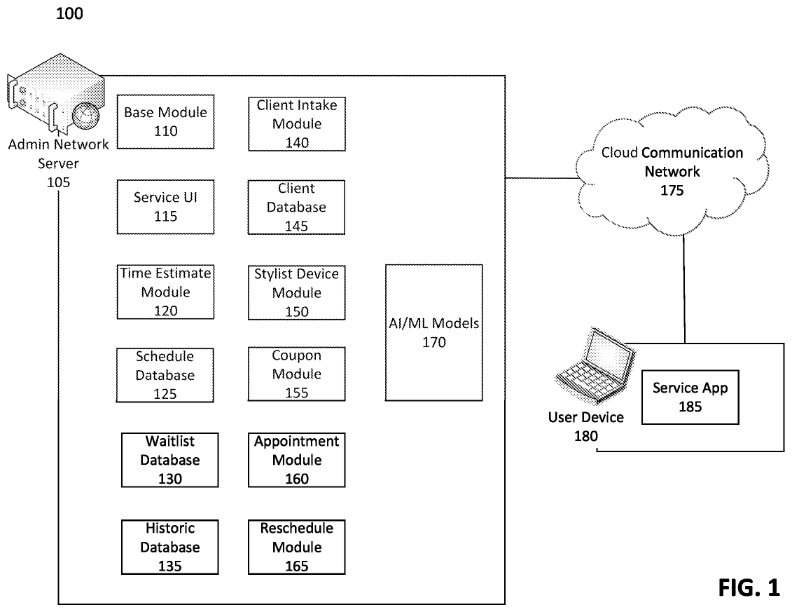

FIG. 1 illustrates an exemplary network environment 100 in which a system of constructing artificial intelligence models for dynamic scheduling may be implemented. As illustrated, the network environment may include an administrative network server 105 using cloud communication network 175 to communicate with user device 180.

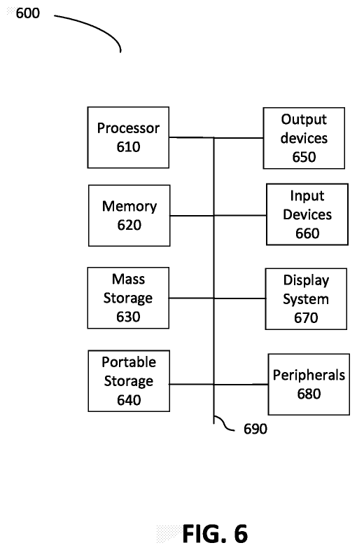

As illustrated, administrative network server 105 may include a base module 110, service UI 115, time estimate module 120, schedule database 125, waitlist database 130, historic database 135, client intake module 140, client database 145, stylist device 150, coupon module 155, appointment module 160, reschedule module 165, and AI/ML models 170. Administrative network server 105 may be a computer or network of computers (such as described in further detail in relation to FIG. 6) that manage the activity of a service provider, such as a hair salon or barbershop. Activities managed by the administrative network server 105 may include, employee scheduling, client intake, data storage, payment processing, accounting, etc.

A base module 110 may initiate other modules on the administrative network server 105. The base module may initiate and control the operations of the other modules of administrative network server 105. In exemplary implementations, the base module 110 may be executed by a process of administrative network server 105 to call time estimate module 120 and the client intake module 140. For example, base module 110 may call on the client intake module 140 to receive client data from one or more user devices 180. The base module 110 may further call and initiate the time estimate module 120 to estimate the remaining wait time for each client in the waitlist database 130.

Meanwhile, service UI 115 may be a user interface that allows employees or managers of the service to clock-in, clock-out, take a client off the waitlist, set the schedule for the day, accept payment, etc. The service UI 115 may also be customized to provide user-specific graphic user interfaces for different users and user devices, which may be associated with service providers or customers.

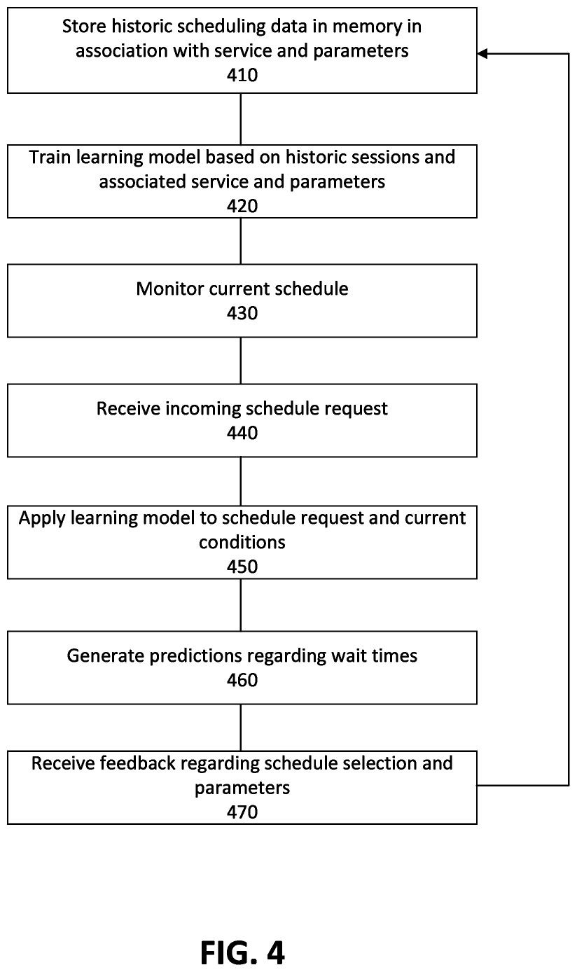

A time estimate module 120 may estimate the amount of time remaining before a client on the waitlist can be seen by a service provider. The estimated time may be calculated based on several factors including the current queue, estimated service times, client history such as usual service selection or expected punctuality, or stylist history such as typical service time or experience level. This calculation may use an AI algorithm which may be iteratively tuned based on if the estimated time was close to the actual wait time. The operations of time estimate module 120 may be discussed in further detail in relation to FIG. 4.

A schedule database 125 may include data regarding the schedules of the service provider or employees of the service provider. Schedules may include daily availability, current availability, or any appointments or otherwise unavailable times. Information in the database may be added or altered via the service UI 115.

A waitlist database 130 may contain a list of clients who are waiting to receive service. The database may include information such as the name of the client or other identifier, the current estimated wait time, or if the client has any special requests such as a specific service provider.

A historic database 135 may contain historic records of services. These records may contain data such as the service provided, the time taken, the service provider, the client, the time of day, the state of the work environment, or any other data which may be useful in estimating how long future services may take.

A client intake module 140 may intake client formation and request to be put on the waitlist. The client information is provided by the client via the service app 185. Not all users may provide the same level of information. For example, some users may provide no information other than location, while others may provide their name, location, and requested service. A processor of administrative network server may execute the client intake module 140 based on an initiation signal or trigger from the base module 110. The client intake module 140 may poll for a connection from the service app 185 on the user device 180. The client intake module 140 may retrieve estimated service end times from the client database 145. If there are multiple service locations, the client intake module may retrieve only those estimated service end times for locations within a set radius, such as 25 miles. The user may be able to select a location to see location specific wait times.

The client intake module 140 may calculate wait time. The client intake module 140 may determine which estimated end time is the earliest in time, then check any future appointments to see if that service provider will have enough time to see the client. For example, Amy is cutting Bob's hair and will be done in an estimated 15 minutes. Casey is cutting Doug's hair and will be done in 20 minutes. The estimated wait time for a new client would be 15 minutes. However, if Amy has an appointment in 25 minutes and a haircut typically takes 15 minutes, then Amy does not have enough time to fit a new client in between Bob and the next appointment. The estimated wait time would be 20 minutes, because that is when it is estimated that Casey will be available. The client intake module 140 may send the estimated wait time to the service app to be displayed to the user.

The client intake module 140 may collect the user's information. Some information may be required to be put on the waitlist, such as the client's name or a type of service. If the user has a preference of service provider they may indicate it. The user may choose to be put on the waitlist or to schedule an appointment. The client intake module 140 may store the collected information in the client database 145. If the user has indicated that they want to be put on the waitlist, then the user will be added to the waitlist database 114 as well. The client intake module 140 may return to polling.

A client database 145 may store data on past or current clients. This data may be used by the time estimate module 120 to estimate the time it will take to provide service to the client based on past visits. It may also be useful to the service provider in identifying which service the client has requested in the past. For example in hair salons, many clients cannot remember the details of the last haircut they had.

A stylist device module 150 may poll for data from the stylist device 180 and take actions based on the data such as updating the waitlist, re-estimating the service time, retrieving client information, etc. For example, a stylist may note on the stylist device 180 that they have finished the first part of a three-part hair dying service. The service time would then be re-estimated because the actual time for the first part of the service is now known. In exemplary implementations, stylist device module 150 may be executed by a processor administrative network server 105 to poll for data from the stylist device (e.g., user device 180). This data may be a request for the stylist device module 130 to retrieve, alter, or store some data on the administrative network server 105 and may also include the data to be altered or stored.

The stylist device module 150 may determine if the data from the stylist device 180 indicates that the stylist is requesting to view a client's profile. This data may include an ID for the client or some other data from which the client could be identified such as a name, picture, username, facial recognition data, etc. If the stylist is requesting to view a client's profile, the stylist device module 150 may retrieve some or all of that client's data from the client database 118. The stylist device module 150 may send the client data from the client database 118 to the stylist device 130. If the stylist is not requesting to view a client's profile, The stylist device module 150 may determine if the data from the stylist device 180 indicates that the stylist is requesting to view the waitlist.

If the stylist is requesting to view the waitlist, the stylist device module 150 may retrieve some or all of the waitlist data from the waitlist database 130. The stylist device module 150 may send the waitlist data to the stylist device 130. If the stylist is not requesting to view the waitlist, the stylist device module 150 may determine if the data from the stylist device 180 indicates that the stylist is updating the status of the current service. For example, a hair dye procedure is done in three distinct parts, washing, dyeing, and touch-up. When the washing is done, the stylist may update the status of the service to indicate the service has moved onto the second part. This change may require the time estimate module 108 to generate a new estimate, if the actual time to finish part one of the procedure is different than the expected time.

If the stylist is updating the status of the current service, the stylist device module 150 may apply the update to the service in the client database 118. If the stylist is not updating the status of the current service, the stylist device module 150 may determine if the data from the stylist device 180 indicates that the stylist is updating the waitlist. For example, the stylist may be taking a client off the waitlist because it is the client's turn for service. If the stylist is updating the waitlist, the stylist device module 150 may update the waitlist database with the stylists changes. For example, if the data from the stylist device 180 has a client ID that client may be removed from the waitlist database and the waitlist may be adjusted accordingly. If the stylist is not updating the waitlist, the stylist device module 150 may continue to poll for new data. There may be additional functionality of the stylist device 130, in which case the stylist device module 150 will not return to polling until the data from the stylist device 180 has been checked against each function.

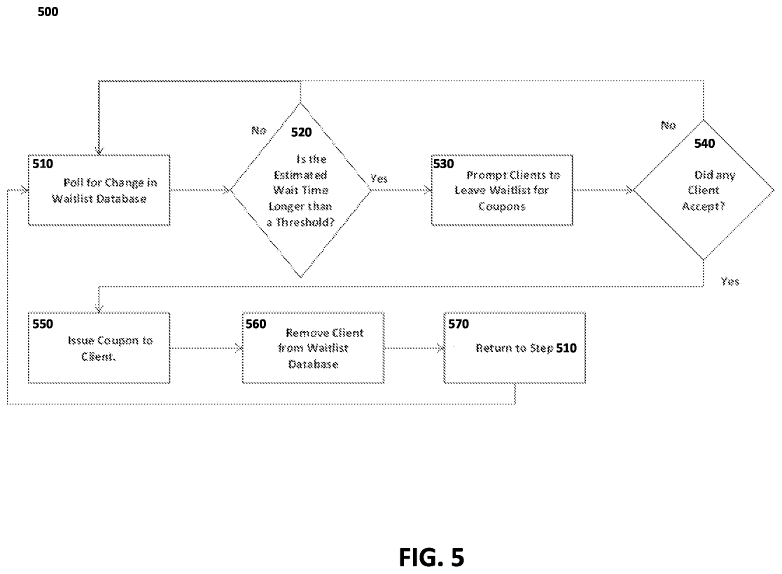

A coupon module 155 may offer coupons to clients for different salons or different times when traffic is high. For example when the estimated wait is over an hour, clients may be given a coupon to go to a nearby salon or a coupon that is not effective until the next day. The coupon module 155 may be executed by a processor of administrative network server 105 to generate and send digital offers to users via their respective user devices when wait times exceed certain predetermined thresholds. The operations of coupon module 155 are described in further detail in relation to FIG. 5.

An appointment module 160 may allow user to make same-day appointments based on openings on the existing waitlist. A user may need to be a member to use this feature. The appointment module 160 may suggest appointment times based on availability, user preference, and user location. The appointment module 160 may be executed by a processor of administrative network server 105 to poll for a same-day appointment request from the service app 185. The request may initiated by the client selecting an option from the service app 185 such as “same-day appointment”. The client may select a location at this time, or all locations within a radius of the client, such as 15 miles, may be included, The appointment module 160 may search the client database 145 for existing appointments for the current day, The appointment module 160 may search the waitlist database 130 for the total current estimated wait time and what time it will be when the waitlist is empty. For example if it is currently 1:00 PM and the total estimated time to get through all the clients on the waitlist is 2 hours then the expected time the waitlist will be empty is 3:00 PM.

The appointment module 160 may display appointment times via the service app 185. Available appointment times may be displayed differently than unavailable appointment times, such as in a different color. Unavailable appointment times may not be displayed. Which appointment times are available may be based on when the waitlist is expected to be empty, and when stylists have availability after the waitlist is empty. For example, the waitlist is expected to be empty at 3:00 PM and every stylist has an appointment from 3:00 PM to 3:30 PM. The earliest available time that day would be 3:30 PM. Note that if the client wants to book with a specific stylist then the schedule of only that stylist may be used to determine availability. Appointment times may be displayed in chronological order, or another order such as an order based on the client's history. For example, a client who consistently books 2:00 PM appointments may have that time slot appear first on the list of appointments, The appointment module 160 may receive the client's selection of appointment time sent from the service app 185 via the client device 180, The appointment module 160 may determine if the selected appointment time is available, If the selected appointment time is available, the appointment module 160 may save the appointment in the client database 145 along with the client information.

The appointment module 160 may also take other steps necessary to book the appointment, such as contacting the stylist. If the selected appointment time is unavailable, the appointment module 160 may save the backup appointment in the client database 145 but not as a booked appointment. For example, the status in the database may be “backup appointment”, “pending appointment”, “unconfirmed appointment”, etc. The reschedule module 165 may allow the client to book an official appointment if the time becomes available. The appointment module 160 may then return to polling. If an appointment at the selected time but a different location is available, the client may be notified. The client may be able to select multiple backup times or may be limited in the number of backup times that can be held as possible appointments. The appointment module 160 may return to polling,

A reschedule module 165 may contact the user when there is a need to reschedule an appointment or if a preferred appointment time has become available. Reschedule module 165 may be executed by a processor of administrative network server 105 to poll for changes in the client database 145 or the schedule database 125. These changes may come from an appointment being canceled, a stylist clocking out, a new appointment being made, etc. The reschedule module 165 may determine if a backup appointment has become available. Backup appointments may refer to an appointment for a time that was unavailable, but that a client has selected as their appointment time if the time slot becomes available. If the time slot is now available, and there is more than one backup appointment for the same time slot, the reschedule module 165 may select the backup appointment that was made the earliest as the one that has become available. If no backup appointment has become available the reschedule module 165 may continue polling for available appointments.

If a backup appointment has become available, the reschedule module 165 may notify the client. The notification may include a link or other method by which the client can instantly book the appointment, The reschedule module 165 may determine if the client has selected to book the available appointment. If the client has not selected to book the available appointment, then the reschedule module 165 may select another backup appointment and notify that client. If there is no other backup appointment, the reschedule module 165 may continue polling for available appointments. If the client has selected to book the available appointment, the reschedule module 165 may change the status of the appointment in the client database 145 from a backup appointment to an appointment. If the client booked another appointment, or has other backup appointments, they may be canceled, The reschedule module 165 may determine if an available appointment has become unavailable. For example, if a stylist leaves earlier than scheduled. If no appointments have become unavailable, the reschedule module 165 may return to polling. If an available appointment has become unavailable, the reschedule module 165 may notify the client.

The notification may include a link, or other method, which may direct the client back to the appointment module 160 to schedule another appointment. The notification may include a coupon, voucher, or some other benefit as an apology for the inconvenience, The reschedule module 165 may return to polling.

AI/ML models 170 may be used to predict wait times based on any combination of session parameters and conditions, etc., The AI/ML models 170 may further correlate different sets of the identified session parameters to different wait times and wait time adjustments. Such AI/ML models 170 may be generated and refined using artificial intelligence and machine learning techniques (e.g., similar to those used by large language models trained using large data corpora to learn patterns and make predictions with complex data) on historical and current session data, as well as supplemental content data.

Artificial intelligence and machine learning techniques may further be applied to train a AI/ML models 170 for a particular service provider based on service session data, including type of service(s), combination of services, service supplies, service provider data (e.g., individual stylists, colorists, etc.), user data, and conditions related to the service sessions. Such service session data may include not only information regarding the service(s) offered and provided by the service provider, but also user profiles, and conditions (e.g., time of day, time of year, holidays, weather, etc., associated with the service session. The session data may be analyzed to determine whether a current wait time estimates are applicable to a particular stylist, service, user, and current real-time conditions. User feedback may be used to refine future predictions and estimates as to wait times and wait time adjustments for future service sessions.

In some implementations, information regarding the user (e.g., favorite drinks, snacks, colors, styles, times of day, etc.) may be received from or otherwise observed in relation to historical data from past service sessions. In addition, session data may be monitored and stored as historical data in memory, which may be used for supervised and unsupervised learning whereby a model may be trained to recognize patterns between certain service types and associated session parameters, as well as to predict wait times that would be likely for a particular user request for certain services. In some implementations, stored service session data may be labeled in accordance with any combination of metadata and user feedback during or in association with historic service sessions.

In exemplary embodiments, stored data files may provide information to AI/ML models 170 regarding current session conditions, which may also be used for evaluating wait times and wait time adjustments. AI/ML models 170 may therefore use such recorded files to identify specific conditions of the current session, including specific customers, stylists, services, etc., that habitually frequent specific locations. Based on such files, for example, AI/ML models 170 may predict a wait time or wait time adjustment associated with the requested type of service(s) under current conditions, which may be used to dynamically generate an custom user interface with different options for scheduling the requested service session.

Such AI/ML models 170 may be updated based on new feedback or analytics of current and historic sessions and user feedback, which may include modifications to add, remove, or change services, extended or abbreviated appointment times, and other changes to the session. Where user preferences are being analyzed, the model may further apply pattern recognition to user-associated session data to identify common characteristics and to predict that a customer is likely to take longer or less time than others. User feedback may indicate certain preferences or ways in which the service may be selected, modified, and/or combined with other services in a manner best-fitting the needs and preferences of the user. Such user feedback may be used not only to tailor subsequent service and wait time predictions for sessions involving the specific user, but also for sessions with users identified as sharing similar user attributes. In that regard, the AI/ML models 170 may not only be constructed for or customized to a particular user or service, but may be used for user groups or service combinations that share similarities. Further, the system may affirm such associations or patterns by querying a user (e.g., service provider or customer) for feedback on whether the original wait time predictions were accurate, whether any changes of the originally requested service(s) were made, and utilize the user feedback to further update and refine the AI/ML models 170, as well as monitoring associated or concurrent conditions for other possible patterns. For example, AI/ML models 170 may also be used to correlate different environmental conditions to different wait time adjustments that may be used to dynamically generate more accurate and timely-presented schedules to all parties.

The AI/ML models 170 may thus be trained to process session data in conjunction with wait time data to identify one or more session parameters that may be positively correlated to wait times or wait time adjustments based on, e.g., input or feedback from the user, user characteristics, prior selections or modifications, one or more parameters for the service, service supplies, service providers, customers, etc. The identified wait times or wait time adjustments may thus be correlated to parameters of a particular service session. Session data may be captured and stored in activity files that may be provided to AI/ML models 170 for analysis as to the current session conditions and thus support analysis of and coordination of different combinations of services to current sessions. Each parameter may be tracked and associated with the metadata associated with for any of the variety of services, entities, objects, locations, etc. Such data may further be aggregated, applied to AI/ML models 170, and subject to analytics to make predictions as to the currently requested session.

Different AI/ML models 170 may be trained using different types of data input, which may be specific to the user, the user demographic, associated service(s) and parameters thereof, etc. Using the selected data inputs, therefore, the AI/ML models 170 may be trained to identify attributes of a specific service and predict wait times or wait time adjustments that may be specifically relevant to the given request.

The cloud or internet 175 may be a wired and/or a wireless communication network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance.

A user device 180 may be a device such as a laptop, smartphone, tablet, computer, or smart speaker, etc., which is inclusive of the computing device described in further detail in relation to FIG. 6. The user device 180 may come installed with or have downloaded a service application 185, which may be an application or web application that allows the user to send and receive information to the administrative network server 105 through the cloud or internet 175.

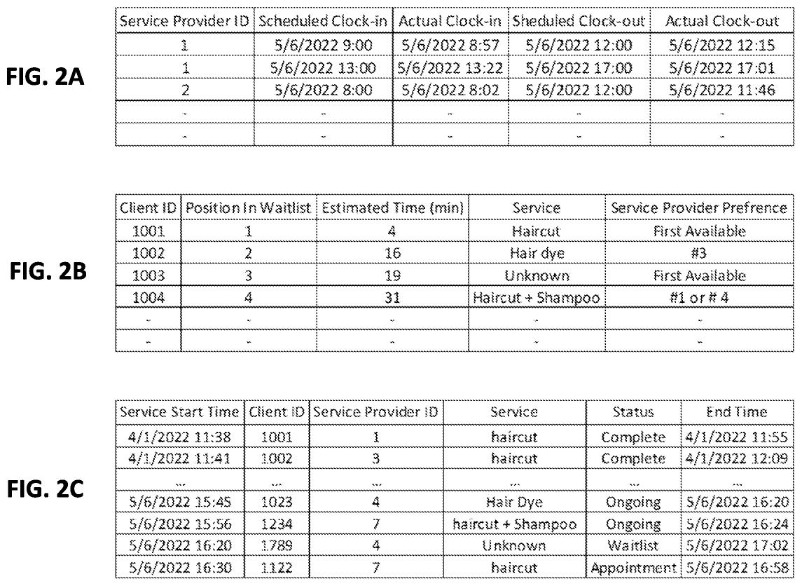

FIG. 2A illustrates an exemplary schedule database 125 that may be used in methods of constructing artificial intelligence models for dynamic scheduling. The schedule database 125 may contain the expected and actual schedules of the service providers. This information is useful in estimating the time before the next available service provider and which service providers are currently able to take clients. Service providers may also refer to independent contractors of solo practitioners that work under the same scheduling system. The schedule database 125 may contain data from past schedules, which could be used to predict service provider behavior. For example, an service provider who often clocks-in early can be expected to clock-in early in the future and this may considered in the wait list estimation.

FIG. 2B illustrates an exemplary waitlist database 130 that may be used in methods of constructing artificial intelligence models for dynamic scheduling. The waitlist database 130 may contain the waitlist data of clients who are in line to receive service. The waitlist database 130 may include an ID for the client, a position in the queue, the estimated wait from the time estimate module 120, the type of service, and any preference of service provider the user may have.

FIG. 2C illustrates an exemplary client database 145 that may be used in methods of constructing artificial intelligence models for dynamic scheduling. The client database 145 may contain data on services received, or to be received, by past or current clients. The client database 145 may contain a service start time, which may be in the future if the user has made an appointment. The client database 145 may contain an ID for the client and service provider, a service provided, and the status of that service. The client database 145 may also contain a service end time, which may be an actual end time if the service is completed. If the service is ongoing or is a future service, then the end time in the client database 145 may be the estimated end time calculated by the time estimate module 120.

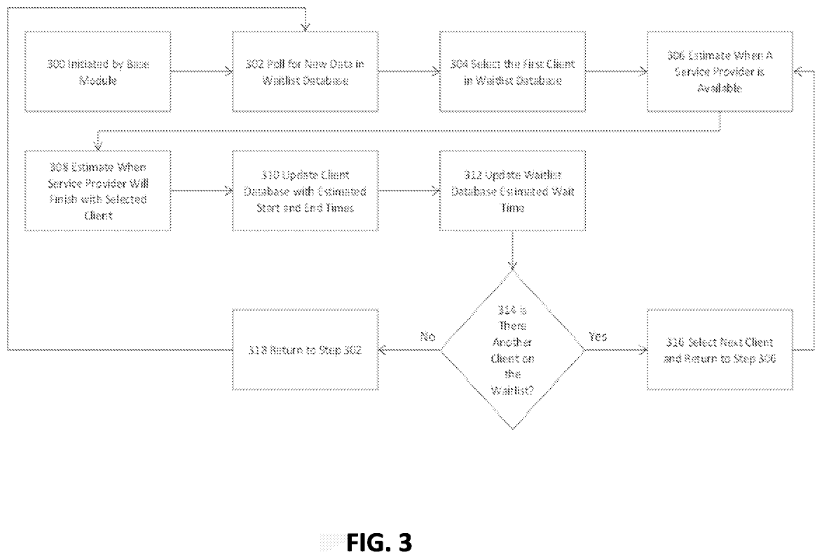

FIG. 3 is a flowchart illustrating an exemplary method of dynamic scheduling based on artificial intelligence models. Actions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The process may begin with the time estimate module 120 being initiated by the base module 110 at step 300. The time estimate module 120 may poll for new data in the waitlist database 130. New data may mean that data has been added, altered, or removed at step 302. In step 304, the time estimate module 120 may select the first client in the waitlist database 130 (or the next client in line to receive service.

In step 306, the time estimate module 120 may estimate when a service provider is available. The time estimate module 120 may check the client database 145 to determine when the next service provider is available. If the client has selected one or more specific provider then the time estimate module 120 may only check those service providers. A user may indicate that they would prefer a specific service provider, but would only wait a set time more for that provider. In which case the time estimate module 120 may estimate the time for the specific provider and compare the time to the first available provider. For example, Bob may prefer to see Amy for a haircut, but is only willing to wait 15 extra minutes. If Casey will be available in 5 minutes and Amy wont be available for another 25, then Bob will be assigned to Casey. The time estimate module 120 may also check to see if the service provider has time to take another client. If the service provider has an appointment or is set to clock out, and does not have enough time to see another client, the estimated end time of their current client will not be counted. The estimated wait time may then be based on the next earliest estimated end time. If there is a service provider that has enough time for a client and is not currently seeing a client, the estimated wait time may be none.

The time to see a client may be based on an average of the service time, which may be specific to that service provider. If no service providers will be available before the end of business, or before a time specified by the client, then the client may be notified of a need to reschedule. This notification may be sent to the service app 185. The service app 185 may provide address data on the client such as geolocation data or coordinate data, or any other absolute position data of the client. The address data may be traditional address data such as street name, city, state, zip code, or any other location data based on landmarks, jurisdictional borders, or local designations. The address data may be used to determine the time it will take the client to arrive at the service provider's location. If the travel time is longer than the estimated wait time, then the client may be given a different position in the waitlist. The client may be assigned a service provider based on how close the client's estimated time of arrival is to the service provider's availability.

In step 308, the time estimate module 120 may estimate how long it will take the assigned service provider to finish providing service to the selected client. The time estimate module 120 may additionally estimate how long it would take any available service provider to finish providing service to the selected client. If there is a service provider that would finish service at an earlier time then the first available service provider, then the client may be given the option to be assigned to that service provider. For example, Amy is currently available to cut Bob's hair, but Casey cuts hair faster. Casey is not available for 5 minutes but would finish cutting Bob's hair at 10:30, whereas Amy would finish at 10:33. Bob would be given the option to wait for Casey to be available. In order to estimate the service time by a service provider, the time estimate module 120 may search the historic database 135 for all records of the assigned service provider.

The time estimate module 120 may only use more recent records in order to capture the current state of the service provider, such as the last 100 services or all the services in the last 12 months. The estimated time may be an average of the filtered results. The results may be further filtered by the type of service if the client has provided that information. The results may be further filtered by any other relevant parameter, such as the client, the time of day, the day of the week, which other service providers are working, weather, etc. When a filter is applied, the time estimate module 120 may determine if the sample size of results is large enough for a meaningful average. For example, Amy has performed 5000 haircuts in the past. Amy has cut Bob's hair 20 times, but has only cut Doug's hair 2 times. When estimating the time of service for Bob, the 20 times Amy has seen Bob may be enough to give a meaningful average. Since Amy has only seen Doug 2 times, the average time of service may be estimated by taking the average of all 5000 haircuts. The time estimate module 120 may use a weighted average which combines the different levels of filtered results. In the example, this would mean that the average of all Amy's 5000 haircuts would be combined with the average of Amy's 2 haircuts for Doug. These weights may be part of an AI algorithm, which alters the weights based on how close the estimated time is to the actual time of service.

There could be many other AI algorithms based on trained AI/ML models 170 that could be used to determine wait times. Another example of AI algorithms that could be used for wait times would be to determine the current traffic for an individual and add traffic delay time to a standard wait time. Another example of AI algorithms that could be used for wait times would be to determine weather patterns for traffic and walking delays and use this data to add to standard travel times for patrons who log onto the system. Another example of AI algorithms that could be used for wait times would be to determine the standard cut times at the salon and then used historical data of the current patrons in process to adjust to get more accurate cut times to predict the future wait times. Another example of AI algorithms that could be used for wait times would be to use the time estimate module 120 may use a pattern processing which looks for historical patterns of for time of day to adjust wait times. Another example of AI algorithms that could be used for wait times would be to use the time estimate module 120 may use a pattern processing which looks for historical patterns of for each location to adjust wait times. Another example of AI algorithms that could be used for wait times would be to use the time estimate module 120 may use a pattern processing which looks for historical patterns of for the salon times to adjust wait times. In should be obvious to those in the art that all the examples mentioned could be combined in various manners, and tested to historical to actual data to determine which are the best adjustments to be made, by salon, by salon and by patrons.

In step 310, the time estimate module 120 may update the client database 145 with the estimated start and end times of the service. The status of this service may be set to “waitlist”. The time estimate module 120 may update the waitlist database 130 with the estimated wait time at step 312. The time estimate module 120 may determine if there is another client in the waitlist database 130 at step 314. If there is another client in the waitlist database 130, the time estimate module 120 may select the next client and return to step 306. “Next” may refer to the next client in the queue at step 316. If there are no other clients in the waitlist database 130, The time estimate module 120 may return to step 302 at step 318.

FIG. 4 is a flowchart illustrating an exemplary method of constructing and training artificial intelligence models for dynamic scheduling. In step 410, historic scheduling data may be stored in memory. Such historic scheduling data may pertain to multiple different service sessions. Each session may include one or more types of services, and each service may include different service parameters. In addition, the session data may further information regarding different conditions under which the session took place. For example, such conditions may include specific individual service providers or agents, products used or provided, location, time of day, time of year, weather, etc. The historic data may be updated in real-time as service sessions are completed, and the associated session data becomes available and stored in memory. Completed service session data may include information regarding changes made to the session, as well as actual wait times or times to complete the service(s).

In step 420, AI/ML models 170 may be trained based on the historic session data to identify patterns and correlations among different sets of data. For example, certain service types and service parameters may be determined to be correlated to certain wait times or wait time adjustments. Certain users may tend to have additional service changes that may also result in different wait times or service times.

In step 430, a current schedule is monitored for changes. Such changes may arise from polling of different user devices (e.g., of service providers or customers), as well as incoming requests sent over cloud communication network 175. In addition, current conditions may also be monitored and tracked for consideration during prediction generation. In step 440, a request may be received by administrative network server 105.

In step 450, the trained AI/ML models 170 may be applied to information in the incoming request. For example, the request may include one or more services, associated service parameters, and user information. Such data in the request may also be combined with related data from historic sessions, e.g., where the user is a regular customer, referred by a regular customer, associated with previous service appointments, etc. The trained AI/ML models 170 may use such data from the request and identified from historic data as input to identify patterns and correlations to unspecified parameters.

In step 460, predictions may be generated based on patterns and correlations identified by the trained AI/ML models 170. Such predictions may pertain to the requested service session and may include predicted wait times, wait time adjustments, and likely modifications or add-ons of the service, which may further result in changed wait times. In some implementations, the trained AI/ML models 170 may identify different possible wait times based on different combinations of parameters. The different wait times and associated combination of parameters may be presented within a custom user interface for selection by the requesting user. For example, the user may have the option of waiting shorter wait times by changing a type of service or service parameters, or waiting longer wait times for a different combination of services. In step 470, user feedback regarding user selection and associated parameters may be tracked, stored, and used to train new iterations of the AI/ML models 170.

FIG. 5 is a flowchart illustrating an exemplary method 500 of dynamically modifying schedules based on artificial intelligence models. In step 510, the coupon module 122 may poll for a change in the waitlist database 112. This change may correspond to a new client being added to the list, a client being removed from the list, or the estimated wait time being changed due to some other factor such as a service that is taking longer than expected or a stylist leaving unexpectedly.

In step 520, the coupon module 122 may determine if the estimated wait time is longer than one hour or another threshold value. This may be based on the client with the highest estimated wait time. The threshold value may be static or dynamic and may be set by an administrator of the system or by another module. If the estimated wait time is not longer than the threshold, the coupon module may return to step 510.

If the estimated wait time is longer than the threshold, the coupon module 122 may proceed to step 530 and generate prompts to clients to remove themselves from the waitlist in exchange for a coupon. This coupon may be for the same salon at a different time or on a different date, or for another salon in a similar location. For example, a coupon may give 50% the service the client was waiting for at a salon 15 miles away, or a coupon may give $20 off any service at the salon the client is currently waiting, but the coupon is only redeemable tomorrow or later.

In step 540, the coupon module 122 may determine if any client accepted the offer to leave the waitlist for the coupon. Any client on the waitlist may be eligible for this offer or only some may be, such as those with wait times longer than one hour or the threshold. Once the waitlist drops below the threshold value, the offer may not be available. If no client accepted, the coupon module may return to 510.

If a client accepted the offer, the coupon module 122 may proceed to step 550 and issue a digital coupon to that client. The coupon may be sent directly to the user device 124 or via contact info for the client such as SMS text or email. The coupon may be sent to a stylist device 130 or other device to be printed.

In step 560, the coupon module 122 may remove a client that accepted the offer from the waitlist database and adjust the waitlist accordingly. The coupon module 122 may return to step 510.

FIG. 6 is a block diagram of an exemplary computing device that may be used to implement an embodiment of the present invention. The computing system 600 of FIG. 6 includes one or more processors 610 and memory 620. Main memory 620 stores, in part, instructions and data for execution by processor 610. Main memory 620 can store the executable code when in operation. The system 600 of FIG. 6 further includes a mass storage device 630, portable storage medium drive(s) 640, output devices 650, user input devices 660, a graphics display 670, and peripheral devices 680.

The components shown in FIG. 6 are depicted as being connected via a single bus 690. However, the components may be connected through one or more data transport means. For example, processor unit 610 and main memory 620 may be connected via a local microprocessor bus, and the mass storage device 630, peripheral device(s) 680, portable storage device 640, and display system 670 may be connected via one or more input/output (I/O) buses.

Mass storage device 630, which may be implemented with a magnetic disk drive or an optical disk drive, is a non-volatile storage device for storing data and instructions for use by processor unit 610. Mass storage device 630 can store the system software for implementing embodiments of the present invention for purposes of loading that software into main memory 620.

Portable storage device 640 operates in conjunction with a portable non-volatile storage medium, such as a floppy disk, compact disk or Digital video disc, to input and output data and code to and from the computer system 600 of FIG. 6. The system software for implementing embodiments of the present invention may be stored on such a portable medium and input to the computer system 600 via the portable storage device 640.

Input devices 660 provide a portion of a user interface. Input devices 660 may include an alpha-numeric keypad, such as a keyboard, for inputting alpha-numeric and other information, or a pointing device, such as a mouse, a trackball, stylus, or cursor direction keys. Additionally, the system 600 as shown in FIG. 6 includes output devices 650. Examples of suitable output devices include speakers, printers, network interfaces, and monitors.

Display system 670 may include a liquid crystal display (LCD) or other suitable display device. Display system 670 receives textual and graphical information, and processes the information for output to the display device.

Peripherals 680 may include any type of computer support device to add additional functionality to the computer system. For example, peripheral device(s) 680 may include a modem or a router.

The components contained in the computer system 600 of FIG. 6 are those typically found in computer systems that may be suitable for use with embodiments of the present invention and are intended to represent a broad category of such computer components that are well known in the art. Thus, the computer system 600 of FIG. 6 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

What is claimed is:

1. A method of providing artificial intelligence models for dynamic scheduling, the method comprising:
storing historic schedule data in memory regarding a plurality of different service sessions, wherein each service session is associated with a type of service and one or more service parameters; and
executing instructions stored in memory, wherein execution of the instructions by a processor:
trains a learning model based on the historic schedule data, wherein the learning model is trained to predict a wait time based on the type of service and the service parameters,
identifies one or more conditions associated with an incoming service request for a requested type of service,
applies the trained learning model to the incoming service request based on the requested type of service and the identified conditions,
predicts one or more wait times for the incoming service request, wherein each predicted wait time is associated with one or more different options, and
generates a custom user interface that presents the predicted wait times in association with the different options, wherein each of the different options is selectable to dynamically schedule a service session in accordance with the requested type of service and service parameters that correspond to the respective selected option.

2. The method of claim 1, further comprising receiving the incoming service request over a communication network from a user device, wherein the incoming service request is initiated by an application executed by the user device.

3. The method of claim 2, further comprising initially adding incoming service request to a waitlist database when the predicted wait times exceed a predetermined threshold, and continuing to update the predicted wait times based on real-time changes to the conditions, wherein the custom user interface is generated when the predicted wait times fall below the predetermined threshold.

4. The method of claim 3, further comprising polling the waitlist database for one or more next incoming requests when the predicted wait times fall below the predetermined threshold.

5. The method of claim 1, further comprising sending the custom user interface over a communication network to a user device, and receiving a selection of one of the different options from the user device over the communication network.

6. The method of claim 5, further comprising dynamically scheduling the service session based on the received selection.

7. The method of claim 6, wherein dynamically scheduling the service session includes identifying a service provider device associated with the service session, and sending a notification to the identified service provider device regarding the service session.

8. The method of claim 1, further comprising receiving feedback regarding the service session, and updating the learning model based on the received feedback.

9. The method of claim 1, further comprising:
receiving another incoming service request for another type of service;
adding the other incoming service request to a waitlist database based on a determination that the predicted wait times exceed a predetermined threshold;
generating a notification that includes an option selectable to change one or more service parameters of the other type of service, wherein the option is associated with a reward; and
storing information in memory regarding assignment of the reward to an account associated with the other incoming service request, wherein the reward is applicable to dynamically schedule a different service session in accordance with the changed service parameters of the other type of service.

10. The method of claim 9, further comprising removing the other incoming service request from the waitlist database based on selection of the option.

11. A system of providing artificial intelligence models for dynamic scheduling, the system comprising:
memory that stores historic schedule data regarding a plurality of different service sessions, wherein each service session is associated with a type of service and one or more service parameters; and
a processor that executes instructions stored in memory, wherein the processor executes the instructions to:
train a learning model based on the historic schedule data, wherein the learning model is trained to predict a wait time based on the type of service and the service parameters,
identify one or more conditions associated with an incoming service request for a requested type of service,
apply the trained learning model to the incoming service request based on the requested type of service and the identified conditions,
predict one or more wait times for the incoming service request, wherein each predicted wait time is associated with one or more different options, and
generate a custom user interface that presents the predicted wait times in association with the different options, wherein each of the different options is selectable to dynamically schedule a service session in accordance with the requested type of service and service parameters that correspond to the respective selected option.

12. The system of claim 11, further comprising a communication interface that receives the incoming service request over a communication network from a user device, wherein the incoming service request is initiated by an application executed by the user device.

13. The system of claim 12, wherein the memory further includes a waitlist database that initially adds an incoming service request when the predicted wait times exceed a predetermined threshold, and wherein the processor executes further instructions to continue to update the predicted wait times based on real-time changes to the conditions, wherein the custom user interface is generated when the predicted wait times fall below the predetermined threshold.

14. The system of claim 13, wherein the processor executes further instructions to poll the waitlist database for one or more next incoming requests when the predicted wait times fall below the predetermined threshold.

15. The system of claim 11, further comprising a communication interface that sends the custom user interface over a communication network to a user device, and receives a selection of one of the different options from the user device over the communication network.

16. The system of claim 15, wherein the processor executes further instructions to dynamically schedule the service session based on the received selection.

17. The system of claim 16, wherein the processor dynamically schedules the service session by identifying a service provider device associated with the service session, and the communication interface sends a notification to the identified service provider device regarding the service session.

18. The system of claim 11, further comprising a communication interface that receives feedback regarding the service session, and wherein the processor executes further instructions to update the learning model based on the received feedback.

19. The system of claim 11, further comprising a communication interface that receives another incoming service request for another type of service over a communication network, and wherein the processor executes further instructions to;
add the other incoming service request to a waitlist database based on a determination that the predicted wait times exceed a predetermined threshold;
generate a notification that includes an option selectable to change one or more service parameters of the other type of service, wherein the option is associated with a reward; and
store information in the memory regarding assignment of the reward to an account associated with the other incoming service request, wherein the reward is applicable to dynamically schedule a different service session in accordance with the changed service parameters of the other type of service.

20. The system of claim 19, wherein the processor executes further instructions to remove the other incoming service request from the waitlist database based on selection of the option.

21. A non-transitory, computer-readable storage medium, having embodied thereon a program executable by a processor to perform a method of providing artificial intelligence models for dynamic scheduling, the method comprising:
storing historic schedule data in memory regarding a plurality of different service sessions, wherein each service session is associated with a type of service and one or more service parameters; and
executing instructions stored in memory, wherein execution of the instructions by a processor:
trains a learning model based on the historic schedule data, wherein the learning model is trained to predict a wait time based on the type of service and the service parameters,
identifies one or more conditions associated with an incoming service request for a requested type of service,
applies the trained learning model to the incoming service request based on the requested type of service and the identified conditions,
predicts one or more wait times for the incoming service request, wherein each predicted wait time is associated with one or more different options, and
generates a custom user interface that presents the predicted wait times in association with the different options, wherein each of the different options is selectable to dynamically schedule a service session in accordance with the requested type of service and service parameters that correspond to the respective selected option.
